(19) United States
(12) Patent Application Publication
(10) Pub. No.: US 2026/0061427 A1
(43) Pub. Date: Mar. 5, 2026

(54) Crushing device for comminuting mineral material

(71) Applicant: Kleemann GmbH, Göppingen (DE)

(72) Inventors: Sebastian Grot, Holzmaden (DE); Steffen Häberle, Herbrechtingen (DE); Till Krauss, Rechberghausen (DE); Jochen Meier, Hülben (DE)

(21) Appl. No.: 19/289,202

(22) Filed: Aug. 4, 2025

(30) Foreign Application Priority Data
Sep. 4, 2024 (DE) 10 2024 125 362.2

(51) Int. Cl. B02C 23/00

(52) U.S. Cl. CPC B02C 23/00; B02C 2210/01

(57) ABSTRACT

A crushing device has a crushing chamber. A comminution device is accommodated in the crushing chamber and the comminution device bears at least one comminution tool. The crushing chamber is delimited by at least one crushing chamber boundary having an inner face facing the crushing chamber and an outer facefacing away from the crushing chamber. The crushing chamber boundary has an inspection opening. A detection device may be held by a mounting for determining the state of wear of the communition tool, disposed in the crushing chamber. The detection device can be moved through the inspection opening between a park position and a detection position, wherein the detection device is disposed outside of the crushing chamber in the park position, and in that, in the park position, the inspection opening is closed by means of a cover.

### RELATED APPLICATIONS

The present application claims priority to German Patent Appl. Ser. No. DE 10 2024 125 362.2 filed Sept. 4, 2024, which is incorporated herein by reference.

### BACKGROUND OF THE DISCLOSURE

### Field of the Disclosure

The disclosure relates to a crushing device for crushing mineral material or the like, having a crusher unit, which has a crushing chamber, wherein a comminution device is accommodated in the crushing chamber, in particular movably, preferably rotatably or in a swiveling manner, wherein the comminution device bears at least one comminution tool, in particular a crushing tool, wherein the crushing chamber is delimited by at least one crushing chamber boundary, wherein the crushing chamber boundary has an inner face facing the crushing chamber and an outer face facing away from the crushing chamber, and wherein the crushing chamber boundary has an inspection opening.

Crushing devices according to the disclosure can, for instance, be designed such that they have a rotor as the comminution device, which rotor is held rotatably in the crushing chamber. Such a crushing device can therefore be an impact crusher, a cone crusher or a gyratory crusher. Alternatively, it can also be a comminution device, in which the comminution device has a crushing body disposed in the crushing chamber in a swiveling manner. Such crushing devices can be jaw crushers, for instance.

The crushing tool can be an exchangeable tool that is interchangeably connected to the comminution tool, for instance. In particular, the crushing tool can be an impact bar, an impact rocker, a crusher spindle, a crusher roll or a crushing jaw.

In the context of the disclosure, the crushing tool does not necessarily have to be part of the movable part (for instance, the rotor or the swiveling crushing body) of the comminution tool. Rather, in the context of the disclosure, the crushing tool can be a part that is disposed in the crushing chamber at least sectionally, for instance an impact rocker or a crushing chamber lining, in particular also a part of the crushing chamber boundary.

### Description of the Prior Art

The crushing chamber of generic crushing devices, in particular rock comminution machines, is very difficult to access due to the nature of the system. The safety measures required to access the crushing chamber render accessibility even more difficult. Regularly checks of the wear parts in the crushing chamber is therefore very time-consuming. To this end, sensor-based wear measurements offer an enormous advantage, both in terms of operator safety and machine downtimes. In addition to a pure wear measurement, which enables the operator to plan the adjustment of the crushing gap as wear progresses and the stockpiling of wear parts and their installation, such a system can detect damage in good time and prevent major machine damage. In addition, sensor-based wear measurements offer significant advantages in terms of measurement accuracy compared to the visual evaluation by the machine operator that is common today.

Solutions are known from the state of the art, in which wear parts of a comminution tool consist of a cast material. The measuring system of the detection device is built directly into the cast part. In cast parts, this can only be achieved at great expense. When the wear part is replaced, the detection device is also replaced, which requires a large number of parts.

Methods that use ultrasound to determine the layer thickness of wear parts are also known (see DE 2 357 432 B2 (U.S. Pat. No. 3,944,146)). Ultrasonic sensors that are used to determine coating thickness usually use a sensor head that is attached directly to the wear part. The sound waves would otherwise be reflected or refracted when the medium changes (e.g. air to steel). Such a sensor arrangement is also impractical.

### Summary of the Disclosure

The disclosure addresses the problem of providing a crushing device of the type mentioned at the beginning, which renders a safe and reliable wear detection possible.

This problem is solved in that a detection device held by a mounting is provided for determining the state of wear of at least one wear part, in particular of the comminution tool, in that the detection device can be moved through the inspection opening between a park position and a detection position, wherein the detection device is disposed outside of the crushing chamber in the park position, and in that, in the park position, the inspection opening is closed by a cover.

The detection device is no longer assigned to the wear part but can be used separately therefrom. In the operating position, the detection device is available inside the crushing chamber and can detect the condition of the wear part. Once the condition of the wear part has been detected, preferably an actuator moves the detection device through the inspection opening into the protected area behind the outer face of the crushing chamber boundary. Preferably, the crushing device can be stopped for a short time to determine the wear of the wear part and then the detection device can be moved into the crushing chamber. This permits the wear part condition to be detected effectively and safely. The risk of damage to the detection device due to the effects of crushed material and/or dust is virtually eliminated. In the park position, the cover closes the inspection opening. In this operating position, contamination, e.g. dust, is prevented from entering the area on the outer face of the crushing chamber boundary and accumulating there. In this area, the detection device is parked in the park position. Accumulated impurities could impair the adjustment movement and the functionality of the detection device. In addition, it is advantageous if the inspection opening is closed, e.g. by means of the cover or part of the mounting, even when the detection device is in the detection position.

In particular, the detection device may be an optical measuring device, for instance a measuring device having a laser scanner or a camera, preferably a stereo camera (in particular a 3D camera) or a 2D camera. It is also conceivable that the detection device has one or more laser distance sensors or ToF cameras. Electromagnetic distance measurement methods such as radar sensors or eddy current sensors or capacitive measurement methods are also conceivable. The detection device may also be referred to as a sensor configured to determine the wear state of at least one wear part in the crushing chamber.

According to the disclosure, the wear part may in particular be the comminution device or a part of the comminution device. It is conceivable that the wear part according to the disclosure is a comminution tool or a part of the comminution tool, for instance the crushing tool. It is also conceivable that the wear part according to the disclosure is the crushing chamber lining or a part of the crushing chamber lining. In the context of the disclosure, a wear part can also be any other component that comes into contact with the material to be crushed or comminuted in the crushing chamber.

According to a preferred variant of the disclosure, provision may be made for the mounting to be movable between the detection position and the park position by means of an actuator. In this way, the detection device can be moved automatically. Preferably, the actuator is held outside of the crushing chamber, at least in the park position in the area of the outer face. In this way, the actuator is also protected on the outer face of the crushing chamber boundary during the crushing operation.

According to a preferred variant of the disclosure, provision may be made for the mounting to have or bear the cover, wherein preferably provision may be made, when the detection device is moved from the detection position to the park position, for the cover to be moved to the position, in which it closes the inspection opening at least sectionally. In this way, the adjustment kinematics for moving the mounting and the cover can be combined in a mechanically advantageous way.

According to a variant of the disclosure, a simple design is achieved if provision is made for the mounting to have a plate-shaped support body, which has an outer end and a closing end opposite from the outer end, wherein in the park position of the detection device the closing end faces the crushing chamber and the outer end faces away from the crushing chamber, and, in the detection position, for the closing end to face away from the crushing chamber and the outer end to face towards the crushing chamber.

The inspection opening can be easily sealed in the park position if provision is made for the closing end to form a circumferential edge that is opposite from the edge of the inspection opening in the detection position and preferably covers it on the outside. In other words, the mounting may therefore have or form the above-mentioned cover, of which the circumferential edge is a component.

A crushing device according to the disclosure can be such that an/the outer end of the mounting accommodates or forms a coupling element, that a spacer is connected to the coupling element, and that the spacer forms an attachment plane, which, in the detection position, forms an angle of less than 60°, preferably an angle of less than 50°, with an opening plane formed by the inspection opening, wherein the angle is greater than 5°, preferably greater than 10°. This renders providing a suitable detection area for the detection device, when it is in the detection position, easy.

A possible variant of the disclosure can be such that the mounting can be moved about a swivel axis of a joint between the detection position and the park position, and that the joint is disposed outside of the crushing chamber in the park position. This means that the joint is located in the protected area on the outside of the crushing chamber boundary during the operation of the crusher.

A possible variant of the disclosure may be such that a holding device is provided, which has a guide element having a longitudinal guide, wherein the swivel axis, about which the mounting can swivel, can be moved along the longitudinal guide and transverse, preferably perpendicular to the closing end, and that the mounting can be moved along the guide element into a reversion area, in which the mounting can be rotated about the swivel axis. This means that the mounting can be moved along the longitudinal guide into the reversion area, for instance starting from the detection position. The mounting is then swiveled and the detection device is rotated to the position assigned to the park position. The mounting can then be returned along the longitudinal guide until it is in its park position. This results in a simple construction and a space-saving design. To ensure that sufficient space is available for the swivel motion of the mounting in the reversion area of such a design, provision may be made for the holding device to have at least one spacer, which keeps the reversion area of the longitudinal guide at a distance from the closing end.

According to the disclosure, the cover at least partially closes the inspection opening when the detection device is in the park position. The mounting may have or form the cover, as also explained above. Alternatively, however, the cover can be formed by a structural unit separate from the mounting. This can preferably be designed such that it can be moved, preferably swiveled, when the detection device has been brought into its park position to close the inspection opening. Thus, for instance, provision may be made for the cover to be movable, preferably swiveling by means of a hinge, coupled directly or indirectly to the boundary wall, and for the cover to be movable between a closed position and an open position independently of the swivel motion of the mounting. It is conceivable that, in the case of a separate design of mounting and cover, both assemblies, namely the mounting and the cover, can each be swiveled about an assigned swivel axis. Preferably, the swivel axes are disposed at an angle to each other, preferably at an angle of 90°. The swivel axes are also preferably in the same plane. This plane can, for instance, be parallel to the outer face of the crushing chamber boundary.

A particularly preferred variant of the disclosure can be such that the cover bears an interchangeably attached wear protection element. During the processing operation of the crushing device, the end of the cover facing the crushing chamber is mechanically impacted by the material crushed in the crushing chamber. This wears down the surface of the wear protection element of the cover. If this wear protection element has reached its wear limit, it can then be replaced with a new wear protection element.

### BRIEF DESCRIPTION OF THE DRAWINGS

The disclosure is explained in greater detail below based on exemplary embodiments shown in the drawings. In the figures,

FIG. 1 shows a schematic representation and side view of a material processing plant having a crusher unit,

FIG. 2 shows a perspective view from the left of a schematic representation of a part of the crusher unit of the material processing plant of FIG. 1

FIG. 3 shows a perspective view of the structural unit of FIG. 2 from the right,

FIG. 4 shows a perspective view of a detection device for the mineral processing plant of FIGS. 1-3,

FIGS. 5 and 6 show perspective views of the detection device as shown in FIG. 4 in two different operating representations,

FIG. 7 shows a side view and a sectional view of the representation of FIG. 5,

FIG. 8 shows a side view and a sectional view of the representation of FIG. 6,

FIG. 9 shows a further design variant of a detection device in perspective view and in a reversion position,

FIG. 10 shows the arrangement of FIG. 9 in a detection position,

FIG. 11 shows a front view of the arrangement of FIGS. 9 and 10 in a park position and

FIG. 12 shows a side view and a sectional view of the representation of FIG. 11.

### DETAILED DESCRIPTION

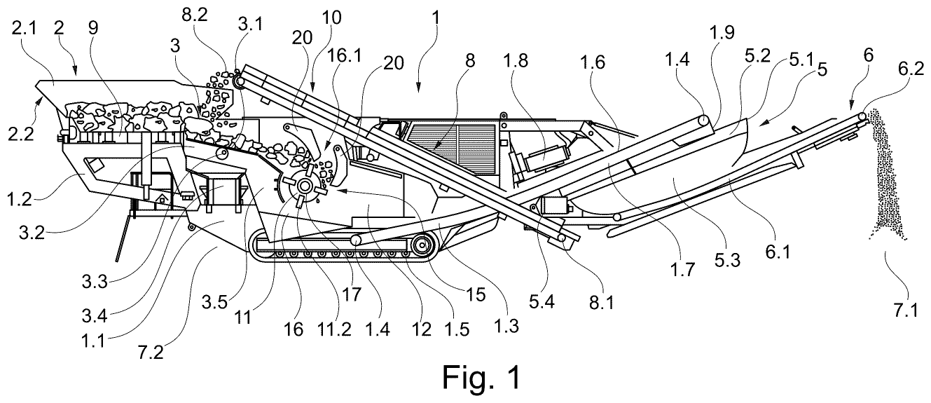

FIG. 1 shows a material processing plant 1 in the form of a crusher having a material processing unit in the form of a crusher unit 10. The material processing plant 1 is designed as a mobile material processing plant 1 and therefore has travel units 1.5. However, it is also conceivable that the material processing plant 1 is a stationary material processing plant 1.

The material processing plant 1 has a chassis 1.1 that bears the machine components or at least a part of the machine components. At its rear end, the chassis 1.1 can preferably have a cantilever 1.2. A material feed area is formed in the area of the cantilever 1.2.

The material feed area may comprise a feed hopper 2 and a material feed device 9.

The feed hopper 2 may be formed at least in part by hopper walls 2.1 extending in the direction of the longitudinal extent of the material processing plant 1 and a rear wall 2.2 extending transversely to the longitudinal extent. The feed hopper 2 leads to the material feed device 9.

As shown in this exemplary embodiment, the material feed device 9 comprise have a conveyor chute that can be driven by means of a vibratory drive. The feed hopper 2 can be used to feed material to be comminuted into the material processing plant 1, for instance using a wheel loader, and to feed it onto the conveyor chute.

As the drawing shows, it may preferable for the material to be comminuted to pass from the conveyor chute into the area of a screen unit 3. This screen unit 3 may also be referred to as a pre-screening arrangement. At least one screen deck 3.1, 3.2 is disposed in the area of the screen unit 3. In this exemplary embodiment two screen decks 3.1, 3.2 are used. A system configuration in which no pre-screen arrangement is used is also conceivable.

A partial fraction of the material to be comminuted is screened out at the upper screen deck 3.1. This partial fraction already has a sufficient particle size that it no longer needs to be comminuted in the material processing plant 1. In this respect, this screened out partial fraction can be routed past the crusher unit 10 through a bypass channel 3.5.

If a second screen deck 3.2 is used in the screen unit 3, a further fine particle fraction can be screened out from the partial fraction that accumulates below the screen deck 3.1. This fine particle fraction can be routed to a lateral discharge conveyor 3.4 below the screen deck 3.2. The fine particle fraction is diverted from the lateral discharge conveyor 3.4 and conveyed to a rock pile 7.2 located laterally of the machine.

As FIG. 1 illustrates, the screen unit 3 may be a vibrating screen having a screen drive 3.3. The screen drive 3.3 causes the screen deck 3.1 and/or the screen deck 3.2 to vibrate. Owing to the inclined arrangement of the screen decks 3.1, 3.2 and in conjunction with the vibration motions, material on the screen decks 3.1, 3.2 is transported towards the crusher unit 10 or towards the bypass channel 3.5.

The material to be comminuted routed from the screen deck 3.1 is routed to the crusher unit 10, as shown in FIG. 1.

The crusher unit 10 can, for instance, take the form of an impact crusher unit, in particular a rotary impact crusher unit, a jaw crusher unit, a cone crusher unit or a gyratory crusher unit. The crusher unit 10 has a comminution device 11.

If a rotary impact crusher unit is used, as in FIG. 1, it has as comminution device 11, for instance, an impact rotor, which is driven by an internal combustion engine 12. In FIG. 1, the axis of rotation 17 of the impact rotor is horizontal in the direction of the image depth. The impact rotor is housed in a crushing chamber 16.1.

If a jaw crushing unit is used, the comminution device 11 has two opposing crushing jaws that enclose a converging crushing shaft between them, resulting in a crushing gap. At least one of the crushing jaws may be driven, for instance by the internal combustion engine 12, to crush the material to be crushed filled in the converging crushing gap.

For instance, the outer circumference of the impact rotor can be fitted with comminution tools 11.2, which are designed as impact bars in this case. Opposite from the impact rotor, for instance, wall elements may be disposed, preferably in the form of impact rockers 20. When the impact rotor is rotating, the impact bars throw the material to be comminuted outwards. In so doing, this material hits the impact rockers 20 and is comminuted due to the high kinetic energy. When the material to be comminuted is of sufficient particle size to allow the material particles to pass through a crushing gap 15 between the impact rockers 20 and the radially outer ends of the impact bars, the comminuted material exits the crusher unit 10 through the crusher outlet 16.

It is conceivable that in the area of the crusher outlet 16, the comminuted material routed from the crusher unit 10 is combined with the material routed from the bypass channel 3.5 and transferred onto a belt conveyor 1.3. The belt conveyor 1.3 can be used to convey the material out of the working area of the crusher unit 10.

As shown in the drawings, the belt conveyor 1.3 may comprise an endless circulating conveyor belt having a slack side 1.6 and a tight side 1.7. The slack side 1.6 is used to catch and transport away the crushed material falling from the crusher outlet 16 of the crusher unit 10. At the belt ends, deflection rollers 1.4 can be used to deflect the conveyor belt from the slack side 1.6 to the tight side 1.7 and vice versa. Guides, in particular pulleys, can be provided in the area between the deflection rollers 1.4 to change the direction of conveyance of the conveyor belt, to shape the conveyor belt in a certain way and/or to support the conveyor belt.

The belt conveyor 1.3 has a belt drive, which can be used to drive the belt conveyor 1.3. The belt drive can preferably be disposed at the discharge end 1.9 or in the area of the discharge end 1.9 of the belt conveyor 1.3.

The belt conveyor 1.3 can be connected, for instance by means of the belt drive, to a control device by means of a control line.

One or more further belt conveyors 6 and/or a return conveyor 8 may be used, which in principle have the same design as the belt conveyor 1.3. In this respect, reference can be made to the above statements.

A magnet 1.8, in particular an electric magnet, can be disposed in particular a, above the slack side 1.6 in the area between the feed end and the discharge end 1.9. The magnet 1.8 can be used to lift iron parts from the broken material and move them out of the conveying area of the belt conveyor 1.3.

A re-screening device 5 can be disposed downstream of the belt conveyor 1.3. The crusher unit 5 has a screen housing 5.1, in which at least one screen deck 5.2 is mounted. Below the screen deck 5.2, a housing base 5.3 is formed, which is used as a collection space for the material screened out at the screen deck 5.2.

An opening in the lower housing part 5.3 creates a spatial connection to the further belt conveyor 6. Here, the further belt conveyor 6 forms its feed area 6.1, wherein the screened material in the feed area 6.1 is directed onto the slack side of the further belt conveyor 6. The further belt conveyor 6 conveys the screened material towards its discharge end 6.2. From there, the screened material is transferred to a rock pile 7.1.

The material not screened out at the screen deck 5.2 of the re-screening device 5 is conveyed from the screen deck 5.2 onto a branch belt 5.4. The branch belt 5.4 can also be designed as a belt conveyor, i.e., reference can be made to the explanations given above with respect to the belt conveyor 1.3. In FIG. 1, the transport direction of the branch belt 5.4 extends in the direction of the image depth.

At its discharge end, the branch belt 5.4 transfers the un-screened material, also referred to as oversize material, to a feed area 8.1 of the return conveyor 8. The return conveyor 8, which may be a belt conveyor, conveys the oversize material towards the feed hopper 2. At its discharge end 8.2, the return conveyor 8 transfers the oversize material into the material flow, in particular into the material feed area. The oversize material can therefore be returned to the crusher unit 10 and crushed to the desired particle size.

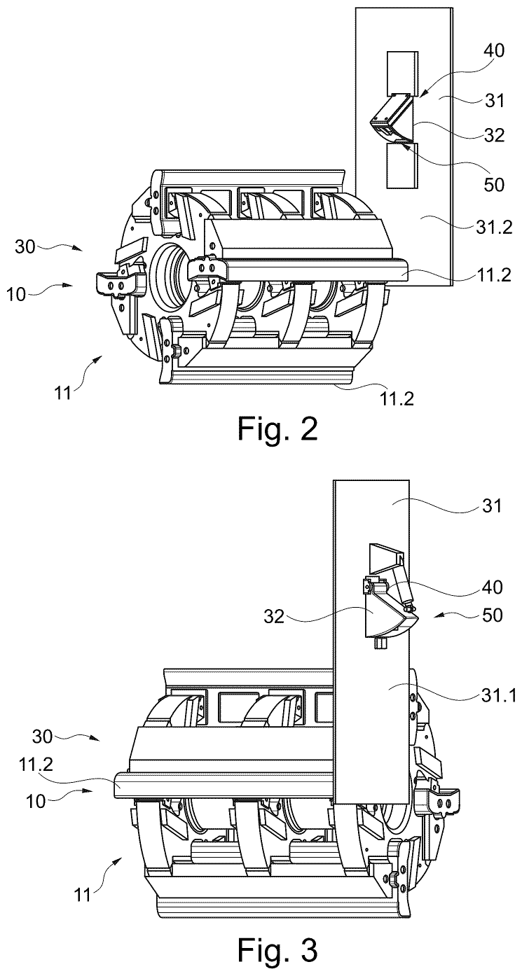

FIGS. 2 and 3 show the comminution devices 11 with their comminution tools 11.2. These are interchangeably held on the rotor of the comminution device 11. As the illustrations show, the comminution device 11 is disposed in the crushing chamber 30. The crushing chamber 30 is closed off from the surroundings, at least sectionally, by means of a crushing chamber boundary 31.

FIGS. 2 and 3 only show an example of a part of a crushing chamber boundary 31. As these figures illustrate, the crushing chamber boundary 31 can be a part of a wall, which has an inner face 31.2 facing the crushing chamber 30 and an outer face 31.1 facing away from the crushing chamber 30. The crushing chamber boundary 31 has an inspection opening 32. The inspection opening 32 can be formed by an aperture that is excluded or recessed from the crushing chamber boundary 31.

In this exemplary embodiment, the inspection opening 32 has the form of a rectangular aperture, which is delimited by opposing horizontal and opposing vertical edge sections.

As the illustrations show, a detection device 50 is disposed in the area of the crushing chamber boundary 31. FIG. 2 shows the detection device 50 in a detection position. In this detection position, the detection device 50 is disposed at least partially in the crushing chamber 30. The detection device 50 can then detect the state of wear of at least one of the comminution tools 11.2 or any other wear part in the crushing chamber 30.

FIG. 3 shows the detection device 50 in a park position. In this park position, the detection device 50 is moved out of the crushing chamber 30 and held in the area behind the outer face 31 of the crushing chamber boundary 31.

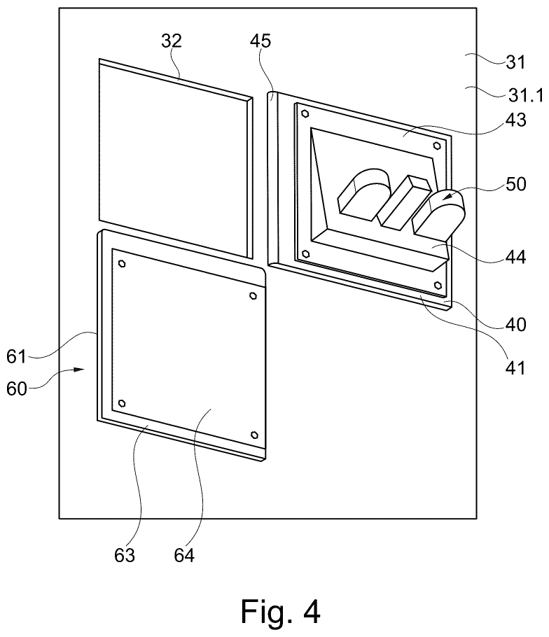

FIG. 4 shows a design variant of a detection device 50 for the crushing device described above in an enlarged detailed view As the illustration shows, the detection device 50 is held on a mounting 40. The mounting 40 is preferably shaped like a plate.

The mounting 40 has an outer end 41 and an opposite closing end 42. The detection device 50 is attached in the area of the outer end 41. Preferably, the detection device 50 is interchangeably attached to the closing end 42 by means of a coupling element 43. The coupling element 43 may have a spacer 44, which holds the detection device 50 at least sectionally at a distance from the outer end 41, as illustrated in FIG. 4.

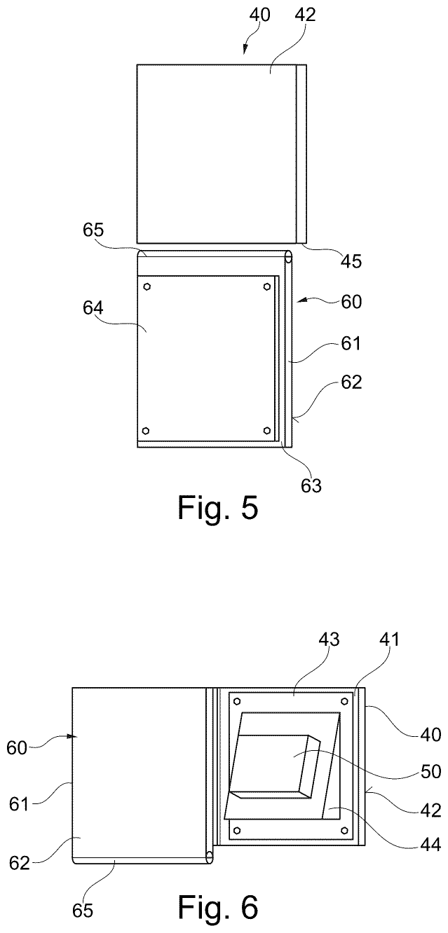

The mounting 40 is preferably coupled to the outside of the crushing chamber boundary 31 in a swiveling manner by means of a joint having a swivel axis 45. Thus, the mounting 40 in conjunction with the detection device 50 can be swiveled about the swivel axis 45 between the park position shown in FIG. 4 and a detection position shown in FIG. 5.

In the park position, the detection device 50 is disposed outside of the crushing chamber 30, as shown in FIGS. 4, 6 and 8.

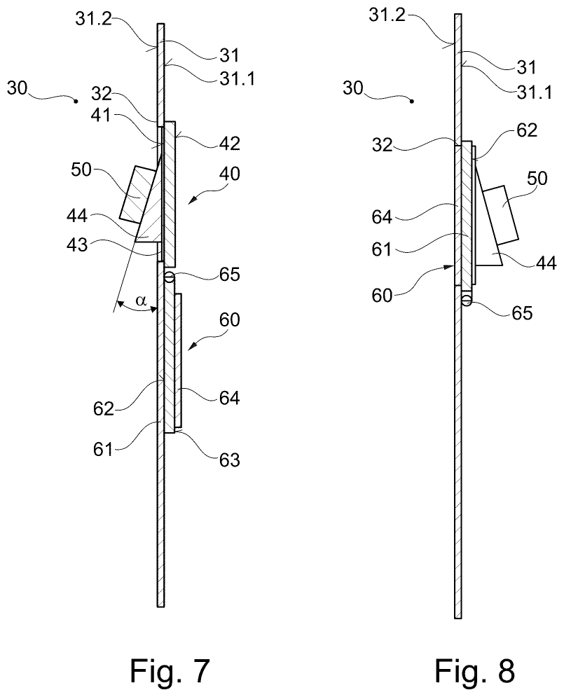

In the detection position, the mounting 40 is moved in such a way that the detection device 50 is held at least sectionally in the crushing chamber 30, as shown in FIGS. 5 and 7.

Thus, the detection device 50 can be moved between its park position and the detection position, wherein during this adjustment movement the detection device 50 is moved through the inspection opening 32.

Preferably, provision is made for the swivel axis 45 to extend in the area of the outer face 31.1 of the crushing chamber boundary 31. The swivel axis 45 is therefore held outside of the crushing chamber 30. The joint, which forms the swivel axis 45, is thus held outside of the crushing chamber 30 in a protected manner in every operating position.

Preferably, in the park position the detection device 50 is accessible from the outer face 31.1 of the crushing chamber boundary 31. This means that the detection device 50 can be easily cleaned in the park position or replaced if maintenance is required.

As FIG. 7 illustrates, the mounting 40, preferably the spacer 44, may form an attachment plane, which, in the detection position, forms an angle a of less than 60°, preferably an angle a of less than 50°, with the opening plane formed by the inspection opening 32, and the angle a may be greater than 5°, preferably greater than 10°. In this way, the detection area of the detection device 50 can be directed away from the inner face 31.2 of the crushing chamber boundary 31 into the crushing chamber 30. The angle can be designed to suit the conditions inside the crushing chamber 30 to enable the best possible detection of the comminution tool 11.2.

When the mounting 40 with the detection device 50 is brought into the park position as shown in FIG. 5, the mounting 40 opens the inspection opening 32. A cover 60 is used to prevent crushed material from entering the area of the outer face 31.1 of the crushing chamber boundary 31 during crushing operation of the material processing plant 1. The cover 60 is used to at least partially, preferably completely, close the inspection opening 32 when the detection device 50 is in the park position.

As shown in FIGS. 4 to 8, the cover 60 may form a separate structural unit from the mounting 40, which can preferably be moved independently of the mounting 40. Preferably provision may be made for the cover 60 to have or form a wall element that has an outer face 62 and an opposite inner face 63.

The cover 60 can preferably be swivel connected to the crushing chamber boundary 30 by means of a hinge 65, as shown in the drawings. Preferably, the hinge 65 is disposed in the region of the outer face 31.1 of the crushing chamber boundary 30, to be held protected outside of the crushing chamber 30. The swivel axis of the hinge 65 forms an angle, preferably an angle of 90°with the swivel axis 45 of the mounting 40.

If the detection device 50 is in the park position, the cover 60 can be swiveled by means of the hinge 65 until it at least partially covers the inspection opening 32. This is shown in FIGS. 6 and 8. In other words, the cover 60 can be moved between the open position shown in FIG. 5 and the closed position shown in FIG. 6.

In the closed position, the edge of the wall element 61 rests on the outer face 31.1 of the crushing chamber boundary 31 to close the inspection opening 32. The inner face 63 then faces the crushing chamber 30.

A wear protection element 64 is preferably interchangeably attached to the inner face 63 of the cover 60, as shown in FIG. 5. The wear protection element 64 is preferably formed by a component, in particular a plate-shaped component, which has at least the same wear resistance as the inner face 31.2 of the crushing chamber boundary 31.

FIG. 8 shows that the wear protection element 64 is preferably flush with the inner face 31.2 in the closed position. Preferably, the cover 60 is inserted into the inspection opening 32 in the closed position. This is clearly shown in FIG. 8.

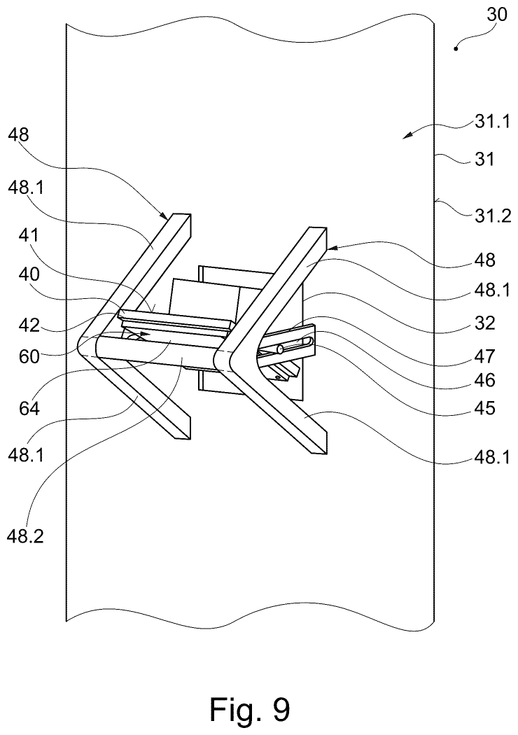

FIGS. 9 to 12 show a further design variant of the disclosure. As this representation illustrates, a holding device 48 is attached to the outer face 31.1 of the crushing chamber boundary 31. The holding device 48 has spacers 48.1, each of which bears a guide element 47 having a longitudinal guide 46. The holding device 48 may also be referred to as a holder 48 or as a bracket 48.

The two longitudinal guides 46 are disposed at opposite ends, in particular at the opposite vertical edge areas of the inspection opening 32. Two spacers 48.1 each are disposed on each end of the inspection opening 32, which form an angle with each other and are interconnected facing away from the outer face 31.1. In the connection area, the spacers 48.1 are connected by means of a connecting piece 48.2, which bridges the inspection opening 32 in the area of the outer face 31.1 at a distance.

The guide elements 47 of the longitudinal guides 46 are designed as slot-shaped mounts, wherein these slots extend perpendicular or substantially perpendicular to the outer face 31.1 of the crushing chamber boundary 31.

Similar to the preceding exemplary embodiment according to FIGS. 4 to 8, a mounting 40 is used, which can be plate-shaped. The mounting 40 has a coupling element 43, which bears the detection device 50 on the outer end 41.1 via a spacer 44, as described above. Reference is made to the above statements.

The mounting 40 has a swivel axis 45 on opposite ends. The swivel axles 45 are guided along the guide elements 47 of the longitudinal guides.

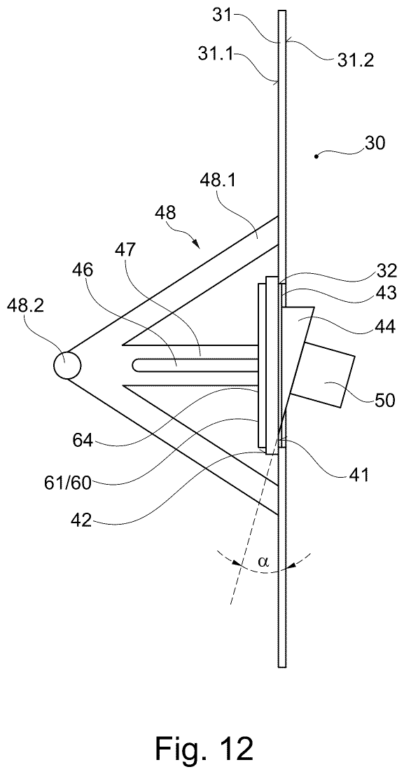

The mounting 40 forms or bears a cover 60 on its closing end 42. The cover 60 has a wall element 61, which is preferably dimensioned such that it can be inserted into the inspection opening 32. This is illustrated in FIG. 12.

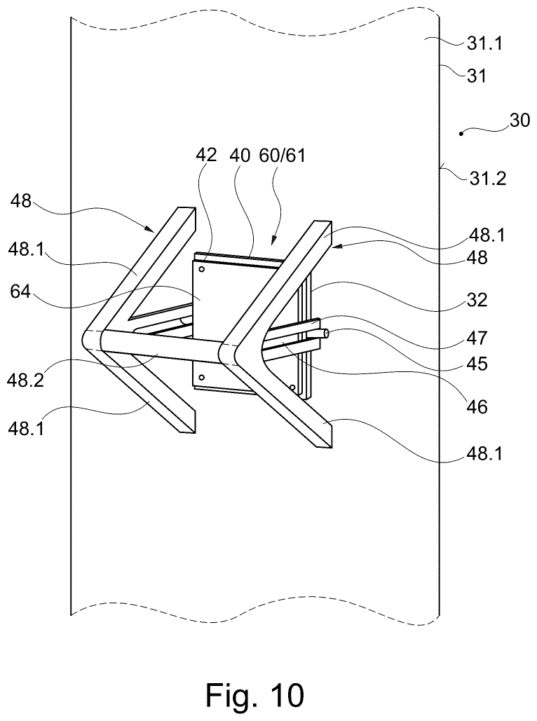

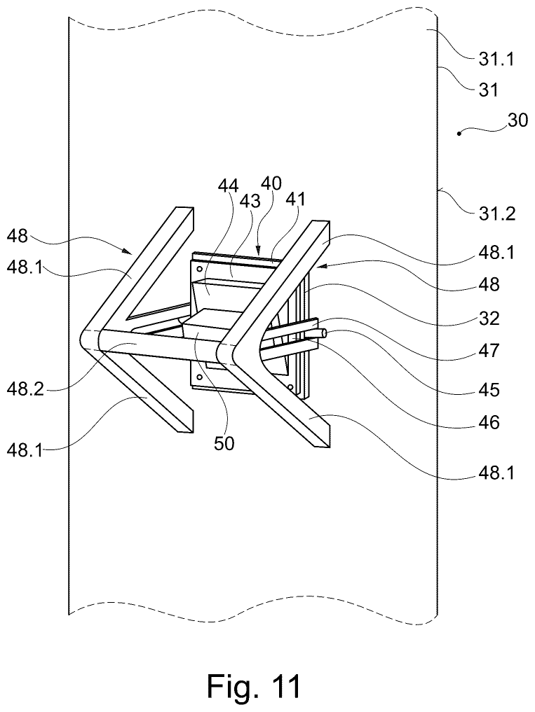

In FIG. 10, the mounting 40 holds the detection device 50 in the detection position. As described above, the detection device 50 is then held in the crushing chamber 30, at least sectionally. If the detection device is now to be moved from the detection position shown in FIG. 10 to the park position shown in FIG. 11, the mounting 40 is first moved linearly along the longitudinal guides 46 perpendicular to the outer face 31.1 of the crushing chamber boundary 31 by means of its swivel axes 45. The movement is made up to a position shown in FIG. 9. This position forms a reversion area. In this reversion area, the mounting 40 can be swiveled about the swivel axes 45, preferably rotated by 180°. In the reversed position, the cover 60 is opposite from the inspection opening. Then the swivel axes 45 pushes the mounting 40 back along the longitudinal guides 46 until the cover 60 is inserted into the inspection opening 32 (see FIG. 11), then the cover 60 closes the inspection opening 32.

FIG. 12 shows that the cover 60 has or bears a wear protection element 64 on the end facing away from the mounting 40. The wear protection element 64 is designed as a plane element. When the cover 60 is inserted into the inspection opening 32, the cover 60, preferably the wear protection element 64, is flush with the inner face 31.2 of the crushing chamber boundary 31.

In the explanations above, the mode of operation of the disclosure was explained with reference to the detection of the wear condition of the comminution tool 11.2. However, the disclosure is not limited to this; rather, the wear condition of any other wear part in the crushing chamber may additionally or alternatively be detected by the detection device 50.

1-13. (canceled)

14. A crushing device for crushing mineral material, comprising:
at least one crushing chamber boundary delimiting a crushing chamber, the at least one crushing chamber boundary including an inner face facing the crushing chamber and an outer face facing away from the crushing chamber, the crushing chamber boundary including an inspection opening;
a comminution device received in the crushing chamber, the comminution device including at least one comminution tool;
a sensor configured to determine a state of wear of at least one wear part in the crushing chamber;
a mounting configured to hold the sensor;
wherein the sensor is configured to be moved at least partially through the inspection opening between a park position wherein the sensor is at least partially outside of the crushing chamber and a detection position wherein the sensor is at least partially inside of the crushing chamber; and
a cover configured to close the inspection opening.

15. The crushing device of claim 14, wherein:
the mounting includes the cover.

16. The crushing device of claim 15, wherein:
the mounting is configured such that when the sensor is moved from the detection position into the park position the cover is moved into a closed position in which the cover at least partially closes the inspection opening.

17. The crushing device of claim 14, wherein:
the mounting includes a plate-shaped support body which has an outer end and a closing end opposite from the outer end;
in the park position the closing end faces the crushing chamber and the outer end faces away from the crushing chamber; and
in the detection position the closing end faces away from the crushing chamber and the outer end faces towards the crushing chamber.

18. The crushing device of claim 17, wherein:
the plate-shaped support body has a circumferential edge which covers the inspection opening from an outside when the sensor is in the detection position.

19. The crushing device of claim 14, wherein:
the mounting includes a spacer forming an attachment plane, the attachment plane in the detection position forming an angle of greater than 5°and less than 60°with an opening plane formed by the inspection opening.

20. The crushing device of claim 14, wherein:
the mounting includes a spacer forming an attachment plane, the attachment plane in the detection position forming an angle of greater than 10°and less than 50°with an opening plane formed by the inspection opening.

21. The crushing device of claim 14, wherein:
the mounting is connected to the at least one crushing chamber boundary by a swivel joint having a swivel axis such that the mounting can be swiveled about the swivel axis between the detection position and the park position of the sensor, the swivel joint being disposed outside of the crushing chamber in the park position.

22. The crushing device of claim 14, wherein:
the mounting is connected to the at least one crushing chamber boundary by a swivel joint having a swivel axis such that the mounting can be swiveled about the swivel axis between the detection position and the park position of the sensor and such that the mounting is swiveled through a swivel angle about the swivel axis of at least 120°between the detection position and the park position of the sensor.

23. The crushing device of claim 14, wherein:
the mounting is connected to the at least one crushing chamber boundary by a swivel joint having a swivel axis such that the mounting can be swiveled about the swivel axis between the detection position and the park position of the sensor and such that the mounting is swiveled through a swivel angle about the swivel axis of at least 150°between the detection position and the park position of the sensor.

24. The crushing device of claim 14, further comprising:
a holder including a longitudinal guide;
wherein the mounting includes a swivel axle defining a swivel axis about which the mounting may swivel, the swivel axle being received in the longitudinal guide such that the swivel axle can be moved along the longitudinal guide into a reversion area in which the mounting can be swiveled about the swivel axis.

25. The crushing device of claim 24, wherein:
the holder includes at least one spacer configured such that the reversion area is spaced a distance from the outer face of the crushing chamber boundary.

26. The crushing device of claim 14, further comprising:
a cover configured to close the inspection opening when the sensor is in the park position.

27. The crushing device of claim 26, wherein:
the cover is part of a cover assembly which can be moved independently of the mounting, and the cover assembly is movable to a closed position closing the inspection opening when the sensor is in the park position.

28. The crushing device of claim 27, wherein:
the cover assembly includes a hinge coupled directly or indirectly to the crushing chamber boundary, wherein the cover is movable between the closed position and an open position in which the cover opens the inspection opening independently of movement of the mounting.

29. The crushing device of claim 14, wherein:
the cover includes an interchangeably attached wear protection element.
